(19) United States
(12) Patent Application Publication
(10) Pub. No.: US 2018/0174311 A1
(43) Pub. Date: Jun. 21, 2018

(54) METHOD AND SYSTEM FOR SIMULTANEOUS SCENE PARSING AND MODEL FUSION FOR ENDOSCOPIC AND LAPAROSCOPIC NAVIGATION

(71) Applicant: Siemens Aktiengesellschaft, Munich (DE)

(72) Inventors: Stefan Kluckner, Berlin (DE); Ali Kamen, Skillman, NJ (US); Terrence Chen, Princeton, NJ (US)

(21) Appl. No.: 15/579,743

(22) PCT Filed: Jun. 5, 2015
(86) PCT No.: PCT/US2015/034327

§ 371 Date: Dec. 5, 2017

(51) Int. Cl. G06T 7/246; G06K 9/32; G06K 9/50; G06T 7/11; G06K 9/62

(52) U.S. Cl. CPC G06T 7/251; G06K 9/3233; G06K 9/50; G06T 7/11; G06K 9/6259; G06T 2207/20081; G06T 2200/04; G06T 2207/10016; G06T 2207/10068; G06T 2207/10081; G06T 2207/10088; G06K 2209/051

(57) ABSTRACT

A method and system for scene parsing and model fusion in laparoscopic and endoscopic 2D/2.5D image data is disclosed. A current frame of an intra-operative image stream including a 2D image channel and a 2.5D depth channel is received. A 3D pre-operative model of a target organ segmented in pre-operative 3D medical image data is fused to the current frame of the intra-operative image stream. Semantic label information is propagated from the pre-operative 3D medical image data to each of a plurality of pixels in the current frame of the intra-operative image stream based on the fused pre-operative 3D model of the target organ, resulting in a rendered label map for the current frame of the intra-operative image stream. A semantic classifier is trained based on the rendered label map for the current frame of the intra-operative image stream.

### BACKGROUND OF THE INVENTION

The present invention relates to semantic segmentation and scene parsing in laparoscopic or endoscopic image data, and more particularly, to simultaneous scene parsing and model fusion in laparoscopic and endoscopic image streams using segmented pre-operative image data.

During minimally invasive surgical procedures, sequences of images are laparoscopic or endoscopic images acquired to guide the surgical procedures. Multiple 2D/2.5D images can be acquired and stitched together to generate a 3D model of an observed organ of interest. However, due to complexity of camera and organ movements, accurate 3D stitching is challenging since such 3D stitching requires robust estimation of correspondences between consecutive frames of the sequence of laparoscopic or endoscopic images.

### BRIEF SUMMARY OF THE INVENTION

The present invention provides a method and system for simultaneous scene parsing and model fusion in intra-operative image streams, such as laparoscopic or endoscopic image streams, using segmented pre-operative image data. Embodiments of the present invention utilize fusion of pre-operative and intra-operative models of a target organ to facilitate the acquisition of scene specific semantic information for acquired frames of an intra-operative image stream. Embodiments of the present invention automatically propagate the semantic information from the pre-operative image data to individual frames of the intra-operative image stream, and the frames with the semantic information can then be used to train a classifier for performing semantic segmentation of incoming intra-operative images.

In one embodiment of the present invention, a current frame of an intra-operative image stream including a 2D image channel and a 2.5D depth channel is received. A 3D pre-operative model of a target organ segmented in pre-operative 3D medical image data is fused to the current frame of the intra-operative image stream. Semantic label information is propagated from the pre-operative 3D medical image data to each of a plurality of pixels in the current frame of the intra-operative image stream based on the fused pre-operative 3D model of the target organ, resulting in a rendered label map for the current frame of the intra-operative image stream. A semantic classifier is trained based on the rendered label map for the current frame of the intra-operative image stream.

These and other advantages of the invention will be apparent to those of ordinary skill in the art by reference to the following detailed description and the accompanying drawings.

### BRIEF DESCRIPTION OF THE DRAWINGS

FIG. 1 illustrates a method for scene parsing in an intra-operative image stream using 3D pre-operative image data according to an embodiment of the present invention;

FIG. 2 illustrates a method of rigidly registering the 3D pre-operative medical image data to the intra-operative image stream according to an embodiment of the present invention;

FIG. 3 illustrates an exemplary scan of the liver and corresponding 2D/2.5D frames resulting from the scan of the liver; and

FIG. 4 is a high-level block diagram of a computer capable of implementing the present invention.

### DETAILED DESCRIPTION

The present invention relates to a method and system for simultaneous model fusion and scene parsing in laparoscopic and endoscopic image data using segmented pre-operative image data. Embodiments of the present invention are described herein to give a visual understanding of the methods for model fusion and scene parsing intraoperative image data, such as laparoscopic and endoscopic image data. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Semantic segmentation of an image focuses on providing an explanation of each pixel in the image domain with respect to defined semantic labels. Due to pixel level segmentation, object boundaries in the image are captured accurately. Learning a reliable classifier for organ specific segmentation and scene parsing in intra-operative images, such as endoscopic and laparoscopic images, is challenging due to variations in visual appearance, 3D shape, acquisition setup, and scene characteristics. Embodiments of the present invention utilize segmented pre-operative medical image data, e.g., segmented liver computed tomography (CT) or magnetic resonance (MR) image data, to generate label maps one the fly in order to train a specific classifier for simultaneous scene parsing in corresponding intra-operative RGB-D image streams. Embodiments of the present invention utilize 3D processing techniques and 3D representations as the platform for model fusion.

According to an embodiment of the present invention, automated and simultaneous scene parsing and model fusion are performed in acquired laparoscopic/endoscopic RGB-D (red, green, blue optical, and computed 2.5D depth map) streams. This enables the acquisition of scene specific semantic information for acquired video frames based on segmented pre-operative medical image data. The semantic information is automatically propagated to the optical surface imagery (i.e., the RGB-D stream) using a frame-by-frame mode under consideration of a biomechanical-based non-rigid alignment of the modalities. This supports visual navigation and automated recognition during clinical procedures and provides important information for reporting and documentation, since redundant information can be reduced to essential information, such as key frames showing relevant anatomical structures or extracting essential key views of the endoscopic acquisition. The methods described herein can be implemented with interactive response times, and thus can be performed in real-time or near real-time during a surgical procedure. Is to be understood that the terms “laparoscopic image” and “endoscopic image” are used interchangeably herein and the term “intra-operative image” refers to any medical image data acquired during a surgical procedure or intervention, including laparoscopic images and endoscopic images.

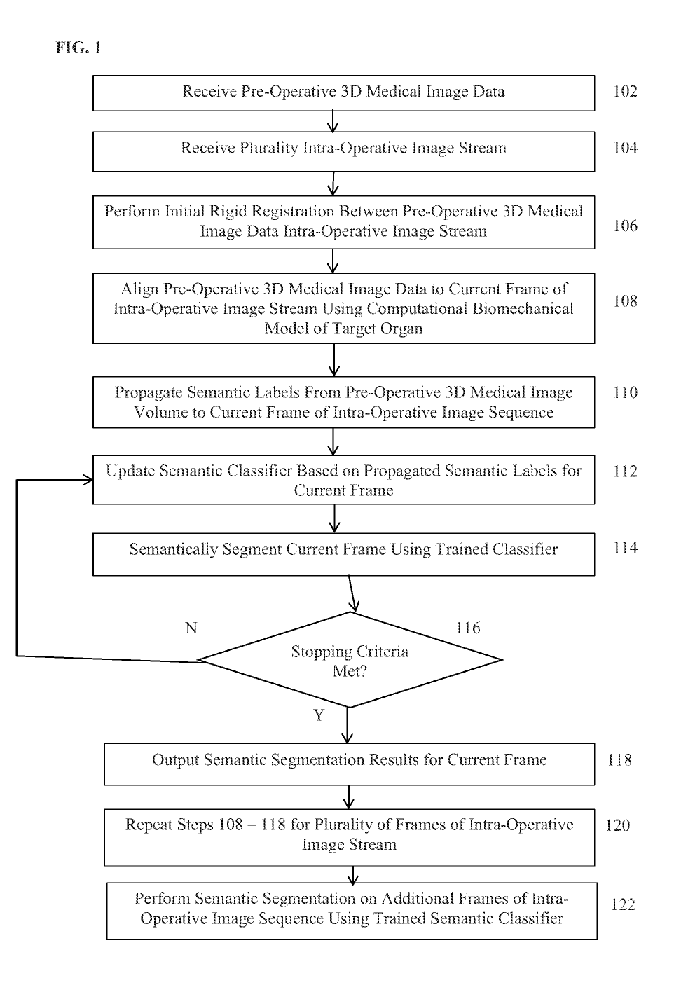

FIG. 1 illustrates a method for scene parsing in an intra-operative image stream using 3D pre-operative image data according to an embodiment of the present invention. The method of FIG. 1 transforms frames of an intra-operative image stream to perform semantic segmentation on the frames in order to generate semantically labeled images and to train a machine learning based classifier for semantic segmentation. In an exemplary embodiment, the method of FIG. 1 can be used to perform scene parsing in frames of an intra-operative image sequence of the liver for guidance of a surgical procedure on the liver, such as a liver resection to remove a tumor or lesion from the liver, using model fusion based on a segmented 3D model of the liver in a pre-operative 3D medical image volume.

Referring to FIG. 1, at step 102, pre-operative 3D medical image data of a patient is received. The pre-operative 3D medical image data is acquired prior to the surgical procedure. The 3D medical image data can include a 3D medical image volume, which can be acquired using any imaging modality, such as computed tomography (CT), magnetic resonance (MR), or positron emission tomography (PET). The pre-operative 3D medical image volume can be received directly from an image acquisition device, such as a CT scanner or MR scanner, or can be received by loading a previously stored 3D medical image volume from a memory or storage of a computer system. In a possible implementation, in a pre-operative planning phase, the pre-operative 3D medical image volume can be acquired using the image acquisition device and stored in the memory or storage of the computer system. The pre-operative 3D medical image can then be loaded from the memory or storage system during the surgical procedure.

The pre-operative 3D medical image data also includes a segmented 3D model of a target anatomical object, such as a target organ. The pre-operative 3D medical image volume includes the target anatomical object. In an advantageous implementation, the target anatomical object can be the liver. The pre-operative volumetric imaging data can provide for a more detailed view of the target anatomical object, as compared to intra-operative images, such as laparoscopic and endoscopic images. The target anatomical object and possibly other anatomical objects are segmented in the pre-operative 3D medical image volume. Surface targets (e.g., liver), critical structures (e.g., portal vein, hepatic system, biliary tract, and other targets (e.g., primary and metastatic tumors) may be segmented from the pre-operative imaging data using any segmentation algorithm. Every voxel in the 3D medical image volume can be labeled with a semantic label corresponding to the segmentation. For example, the segmentation can be a binary segmentation in which each voxel in the 3D medical image is labeled as foreground (i.e., the target anatomical structure) or background, or the segmentation can have multiple semantic labels corresponding to multiple anatomical objects as well as a background label. For example, the segmentation algorithm may be a machine learning based segmentation algorithm. In one embodiment, a marginal space learning (MSL) based framework may be employed, e.g., using the method described in U.S. Pat. No. 7,916,919, entitled “System and Method for Segmenting Chambers of a Heart in a Three Dimensional Image,” which is incorporated herein by reference in its entirety. In another embodiment, a semi-automatic segmentation technique, such as, e.g., graph cut or random walker segmentation can be used. The target anatomical object can be segmented in the 3D medical image volume in response to receiving the 3D medical image volume from the image acquisition device. In a possible implementation, the target anatomical object of the patient is segmented prior to the surgical procedure and stored in a memory or storage of a computer system, and then the segmented 3D model of the target anatomical object is loaded from the memory or storage of the computer system at a beginning or the surgical procedure.

At step 104, an intra-operative image stream is received. The intra-operative image stream can also be referred to as a video, with each frame of the video being an intra-operative image. For example, the intra-operative image stream can be a laparoscopic image stream acquired via a laparoscope or an endoscopic image stream acquired via an endoscope. According to an advantageous embodiment, each frame of the intra-operative image stream is a 2D/2.5D image. That is, each frame of the intra-operative image sequence includes a 2D image channel that provides 2D image appearance information for each of a plurality of pixels and a 2.5D depth channel that provides depth information corresponding to each of the plurality of pixels in the 2D image channel. For example, each frame of the intra-operative image sequence can be an RGB-D (Red, Green, Blue+Depth) image, which includes an RGB image, in which each pixel has an RGB value, and a depth image (depth map), in which the value of each pixel corresponds to a depth or distance of the considered pixel from the camera center of the image acquisition device (e.g., laparoscope or endoscope). It can be noted that the depth data represents a 3D point cloud of a smaller scale. The intra-operative image acquisition device (e.g., laparoscope or endoscope) used to acquire the intra-operative images can be equipped with a camera or video camera to acquire the RGB image for each time frame, as well as a time of flight or structured light sensor to acquire the depth information for each time frame. The frames of the intra-operative image stream may be received directly from the image acquisition device. For example, in an advantageous embodiment, the frames of the intra-operative image stream can be received in real-time as they are acquired by the intra-operative image acquisition device. Alternatively, the frames of the intra-operative image sequence can be received by loading previously acquired intra-operative images stored on a memory or storage of a computer system.

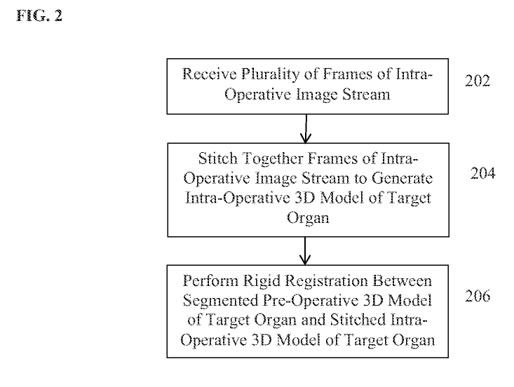

At step 106, an initial rigid registration is performed between the 3D pre-operative medical image data and the intra-operative image stream. The initial rigid registration aligns the segmented 3D model of the target organ in the pre-operative medical image data with a stitched 3D model of target organ generated from a plurality of frames of the intra-operative image stream. FIG. 2 illustrates a method of rigidly registering the 3D pre-operative medical image data to the intra-operative image stream according to an embodiment of the present invention. The method of FIG. 2 can be used to implement step 106 of FIG. 1.

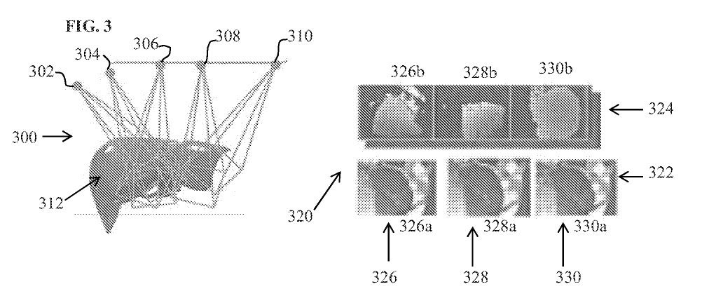

Referring to FIG. 2, at step 202, a plurality of initial frames of the intra-operative image stream are received. According to an embodiment of the present invention, the initial frames of the intra-operative image stream can be acquired by a user (e.g., doctor, clinician, etc.) performing a complete scan of the target organ using the image acquisition device (e.g., laparoscope or endoscope). In this case the user moves the intra-operative image acquisition device while the intra-operative image acquisition device continually acquires images (frames), so that the frames of the intra-operative image stream cover the complete surface of the target organ. This may be performed at a beginning of a surgical procedure to obtain a full picture of the target organ at a current deformation. Accordingly, a plurality of initial frames of the intra-operative image stream can be used for the initial registration of the pre-operative 3D medical image data to the intra-operative image stream, and then subsequent frames of the intra-operative image stream can be used for scene parsing and guidance of the surgical procedure. FIG. 3 illustrates an exemplary scan of the liver and corresponding 2D/2.5D frames resulting from the scan of the liver. As shown in FIG. 3, image 300 shows an exemplary scan of the liver, in which a laparoscope is positioned at a plurality of positions 302, 304, 306, 308, and 310 and each position the laparoscope is oriented with respect to the liver 312 and a corresponding laparoscopic image (frame) of the liver 312 is acquired. Image 320 shows a sequence of laparoscopic images having an RGB channel 322 and a depth channel 324. Each frame 326, 328, and 330 of the laparoscopic image sequence 320 includes an RGB image 326a, 328a, and 330a, and a corresponding depth image 326b, 328b, and 330b, respectively.

Returning to FIG. 2, at step 204, a 3D stitching procedure is performed to stitch together the initial frames of the intra-operative image stream to form an intra-operative 3D model of the target organ. The 3D stitching procedure matches individual frames in order to estimate corresponding frames with overlapping image regions. Hypotheses for relative poses can then be determined between these corresponding frames by pairwise computations. In one embodiment, hypotheses for relative poses between corresponding frames are estimated based on corresponding 2D image measurements and/or landmarks. In another embodiment, hypotheses for relative poses between corresponding frames are estimated based on available 2.5D depth channels. Other methods for computing hypotheses for relative poses between corresponding frames may also be employed. The 3D stitching procedure can then apply a subsequent bundle adjustment step to optimize the final geometric structures in the set of estimated relative pose hypotheses, as well as the original camera poses with respect to an error metric defined in the 2D image domain by minimizing a 2D re-projection error in pixel space or in metric 3D space where a 3D distance is minimized between corresponding 3D points. After optimization, the acquired frames and their computed camera poses are represented in a canonical world coordinate system. The 3D stitching procedure stitches the 2.5D depth data into a high quality and dense intra-operative 3D model of the target organ in the canonical world coordinate system. The intra-operative 3D model of the target organ may be represented as a surface mesh or may be represented as a 3D point cloud. The intra-operative 3D model includes detailed texture information of the target organ. Additional processing steps may be performed to create visual impressions of the intra-operative image data using, e.g., known surface meshing procedures based on 3D triangulations.

At step 206, the segmented 3D model of the target organ (pre-operative 3D model) in the pre-operative 3D medical image data is rigidly registered to the intra-operative 3D model of the target organ. A preliminarily rigid registration is performed to align the segmented pre-operative 3D model of the target organ and the intra-operative 3D model of the target organ generated by the 3D stitching procedure into a common coordinate system. In one embodiment, registration is performed by identifying three or more correspondences between pre-operative 3D model and the intra-operative 3D model. The correspondences may be identified manually based on anatomical landmarks or semi-automatically by determining unique key (salient) points, which are recognized in both the pre-operative model 214 and the 2D/2.5D depth maps of the intra-operative model. Other methods of registration may also be employed. For example, more sophisticated fully automated methods of registration include external tracking of probe 208 by registering the tracking system of probe 208 with the coordinate system of the pre-operative imaging data a priori (e.g., through an intra-procedural anatomical scan or a set of common fiducials). In an advantageous implementation, once the pre-operative 3D model of the target organ is rigidly registered to the intra-operative 3D model of the target organ, texture information is mapped from the intra-operative 3D model of the target organ to the pre-operative 3D model to generate a texture-mapped 3D pre-operative model of target organ. The mapping may be performed by representing the deformed pre-operative 3D model as a graph structure. Triangular faces visible on the deformed pre-operative model correspond to nodes of the graph and neighboring faces (e.g., sharing two common vertices) are connected by edges. The nodes are labeled (e.g. color cues or semantic label maps) and the texture information is mapped based on the labeling. Additional details regarding the mapping of the texture information are described in International Patent Application No. PCT/US2015/28120, entitled “System and Method for Guidance of Laparoscopic Surgical Procedures through Anatomical Model Augmentation”, filed Apr. 29, 2015, which is incorporated herein by reference in its entirety.

Returning to FIG. 1, at step 108, the pre-operative 3D medical image data is aligned to a current frame of the intra-operative image stream using a computation biomechanical model of the target organ. This step fuses the pre-operative 3D model of the target organ to the current frame of the intra-operative image stream. According to an advantageous implementation, the biomechanical computational model is used to deform the segmented pre-operative 3D model of the target organ to align the pre-operative 3D model with the captured 2.5D depth information for the current frame. Performing frame-by-frame non-rigid registration handles natural motions like breathing and also copes with motion related appearance variations, such as shadows and reflections. The biomechanical model based registration automatically estimates correspondences between the pre-operative 3D model and the target organ in the current frame using the depth information of the current frame and derives modes of deviations for each of the identified correspondences. The modes of deviations encode or represent spatially distributed alignment errors between the pre-operative model and the target organ in the current frame at each of the identified correspondences. The modes of deviations are converted to 3D regions of locally consistent forces, which guide the deformation of the pre-operative 3D model using a computational biomechanical model for the target organ. In one embodiment, 3D distances may be converted to a force by performing normalization or weighting concepts

The biomechanical model for the target organ can simulate deformation of the target organ based on mechanical tissue parameters and pressure levels. To incorporate this biomechanical model into a registration framework, the parameters are coupled with a similarity measure, which is used to tune the model parameters. In one embodiment, the biomechanical model represents the target organ as a homogeneous linear elastic solid whose motion is governed by the elastodynamics equation. Several different methods may be used to solve this equation. For example, the total Lagrangian explicit dynamics (TLED) finite element algorithm may be used as computed on a mesh of tetrahedral elements defined in the pre-operative 3D model. The biomechanical model deforms mesh elements and computes the displacement of mesh points of the pre-operative 3D model based on the regions of locally consistent forces discussed above by minimizing the elastic energy of the tissue. The biomechanical model is combined with a similarity measure to include the biomechanical model in the registration framework. In this regard, the biomechanical model parameters are updated iteratively until model convergence (i.e., when the moving model has reached a similar geometric structure than the target model) by optimizing the similarity between the correspondences between the target organ in the current frame of the intra-operative image stream and the deformed pre-operative 3D model. As such, the biomechanical model provides a physically sound deformation of pre-operative model consistent with the deformations of the target organ in the current frame, with the goal to minimize a pointwise distance metric between the intra-operatively gathered points and the deformed pre-operative 3D model. While the biomechanical model for the target organ is described herein with respect to the elastodynamics equation, it should be understood that other structural models (e.g., more complex models) may be employed to take into account the dynamics of the internal structures of the target organ. For example, the biomechanical model for the target organ may be represented as a nonlinear elasticity model, a viscous effects model, or a non-homogeneous material properties model. Other models are also contemplated. The biomechanical model based registration is described in additional detail in International Patent Application No. PCT/US2015/28120, entitled “System and Method for Guidance of Laparoscopic Surgical Procedures through Anatomical Model Augmentation”, filed Apr. 29, 2015, which is incorporated herein by reference in its entirety.

At step 110, semantic labels are propagated from the 3D pre-operative medical image data to the current frame of the intra-operative image stream. Using the rigid registration and non-rigid deformation calculated in steps 106 and 108, respectively, an accurate relation between the optical surface data and underlying geometric information can be estimated and thus, semantic annotations and labels can be reliably transferred from the pre-operative 3D medical image data to the current image domain of the intra-operative image sequence by model fusion. For this step, the pre-operative 3D model of the target organ is used for the model fusion. The 3D representation enables an estimation of dense 2D to 3D correspondences and vice versa, which means that for every point in a particular 2D frame of the intra-operative image stream corresponding information can be exactly accessed in the pre-operative 3D medical image data. Thus, using the computed poses of the RGB-D frames of the intra-operative stream, visual, geometric, and semantic information can be propagated from the pre-operative 3D medical image data to each pixel in each frame of the intra-operative image stream. The established links between each frame of the intra-operative image stream and the labeled pre-operative 3D medical image data is then used to generate initially labeled frames. That is, the pre-operative 3D model of the target organ is fused with the current frame of the intra-operative image stream by transforming the pre-operative 3D medical image data using the rigid registration and non-rigid deformation. Once the pre-operative 3D medical image data is aligned to fuse the pre-operative 3D model of the target organ with the current frame, a 2D projection image corresponding to the current frame is defined in the pre-operative 3D medical image data using rendering or similar visibility checks based techniques (e.g., AABB trees or Z-Buffer based rendering), and the semantic label (as well as visual and geometric information) for each pixel location in the 2D projection image is propagated to the corresponding pixel in the current frame, resulting in a rendered label map for the current and aligned 2D frame.

At step 112, an initially trained semantic classifier is updated based on the propagated semantic labels in the current frame. The trained semantic classifier is updated with scene specific appearance and 2.5D depth cues from the current frame based on the propagated semantic labels in the current frame. The semantic classifier is updated by selecting training samples from the current frame and re-training the semantic classifier with the training samples from the current frame included in the pool of training samples used to re-train the semantic classifier. The semantic classifier can be trained using an online supervised learning technique or quick learners, such as random forests. New training samples from each semantic class (e.g., target organ and background) are sampled from the current frame based on the propagated semantic labels for the current frame. In a possible implementation, a predetermined number of new training samples can be randomly sampled for each semantic class in the current frame at each iteration of this step. In another possible implementation, a predetermined number of new training samples can be randomly sampled for each semantic class in the current frame in a first iteration of this step and training samples can be selected in each subsequent iteration by selecting pixels that were incorrectly classifier using the semantic classifier trained in the previous iteration.

Statistical image features are extracted from an image patches surrounding each of the new training samples in the current frame and the feature vectors for the image patches are used to train the classifier. According to an advantageous embodiment, the statistical image features are extracted from the 2D image channel and the 2.5D depth channel of the current frame. Statistical image features can be utilized for this classification since they capture the variance and covariance between integrated low-level feature layers of the image data. In advantageous implementation, the color channels of the RGB image of the current frame and the depth information from the depth image of the current frame are integrated in the image patch surrounding each training sample in order to calculate statistics up to a second order (i.e., mean and variance/covariance). For example, statistics such as the mean and variance in the image patch can be calculated for each individual feature channel, and the covariance between each pair of feature channels in the image patch can be calculated by considering pairs of channels. In particular, the covariance between involved channels provides a discriminative power, for example in liver segmentation, where a correlation between texture and color helps to discriminate visible liver segments from surrounding stomach regions. The statistical features calculated from the depth information provide additional information related to surface characteristics in the current image. In addition to the color channels of the RGB image and the depth data from the depth image, the RGB image and/or the depth image can be processed by various filters and the filter responses can also be integrated and used to calculated additional statistical features (e.g., mean, variance, covariance) for each pixel. For example, filters such as derivation filters, filter banks. For example, any kind of filtering (e.g., derivation filters, filter banks, etc.) can be used in addition to operating on pure RGB values. The statistical features can be efficiently calculated using integral structures and parallelized, for example using a massively parallel architecture such as a graphics processing unit (GPU) or general purpose GPU (GPGPU), which enables interactive responses times. The statistical features for an image patch centered at a certain pixel are composed into a feature vector. The vectorized feature descriptors for a pixel describe the image patch that is centered at that pixel. During training, the feature vectors are assigned the semantic label (e.g., liver pixel vs. background) that was propagated to the corresponding pixel from the pre-operative 3D medical image data and are used to train a machine learning based classifier. In an advantageous embodiment, a random decision tree classifier is trained based on the training data, but the present invention is not limited thereto, and other types of classifiers can be used as well. The trained classifier is stored, for example in a memory or storage of a computer system.

Although step 112 is described herein as updating a trained semantic classifier, it is to be understood that this step may also be implemented to adapt an already established trained semantic classifier to new sets of training data (i.e., each current frame) as they become available, or to initiate a training phase for a new semantic classifier for one or more semantic labels. In this case in which a new semantic classifier is being trained, the semantic classifier can be initially trained using one frame or alternatively, steps 108 and 110 can be performed for multiple frames to accumulate a larger number of training samples and then the semantic classifier can be trained using training samples extracted from multiple frames.

At step 114, the current frame of the intra-operative image stream is semantically segmented using the trained semantic classifier. That is, the current frame, as originally acquired, is segmenting using the trained semantic classifier that was updated in step 112. In order to perform semantic segmentation of the current frame of the intra-operative image sequence, a feature vector of statistical features is extracted for an image patch surrounding each pixel of the current frame, as described above in step 112. The trained classifier evaluates the feature vector associated with each pixel and calculates a probability for each semantic object class for each pixel. A label (e.g., liver or background) can also be assigned to each pixel based on the calculated probability. In one embodiment, the trained classifier may be a binary classifier with only two object classes of target organ or background. For example, the trained classifier may calculate a probability of being a liver pixel for each pixel and based on the calculated probabilities, classify each pixel as either liver or background. In an alternative embodiment, the trained classifier may be a multi-class classifier that calculates a probability for each pixel for multiple classes corresponding to multiple different anatomical structures, as well as background. For example, a random forest classifier can be trained to segment the pixels into stomach, liver, and background.

At step 116, it is determined whether a stopping criteria is met for the current frame. In one embodiment, the semantic label map for the current frame resulting from the semantic segmentation using the trained classifier is compared to the label map for the current frame propagated from the pre-operative 3D medical image data, and the stopping criteria is met when the label map resulting from the semantic segmentation using the trained semantic classifier converges to the label map propagated from the pre-operative 3D medical image data (i.e., an error between the segmented target organ in the label maps is less than a threshold). In another embodiment, the semantic label map for the current frame resulting from the semantic segmentation using the trained classifier at the current iteration is compared to a label map resulting from the semantic segmentation using the trained classifier at the previous iteration, and the stopping criteria is met when change in the pose of the segmented target organ in the label maps from the current and previous iteration is less than a threshold. In another possible embodiment, the stopping criteria is met when a predetermined maximum number of iterations of steps 112 and 114 are performed. If it is determined that the stopping criteria is not met, the method returns to step 112 and extracts more training samples from the current frame and updates the trained classifier again. In a possible implementation, pixels in the current frame that were incorrectly classified by the trained semantic classifier in step 114 are selected as training samples when step 112 is repeated. If it is determined that the stopping criteria is met, the method proceeds to step 118.

At step 118, the semantically segmented current frame is output. For example, the semantically segmented current frame can be output, for example, by displaying the semantic segmentation results (i.e., the label map) resulting from the trained semantic classifier and/or the semantic segmentation results resulting from the model fusion and semantic label propagation from the pre-operative 3D medical image data on a display device of a computer system. In a possible implementation, the pre-operative 3D medical image data, and in particular the pre-operative 3D model of the target organ, can be overlaid on the current frame when the current frame is displayed on a display device.

In an advantageous embodiment, a semantic label map can be generated based on the semantic segmentation of the current frame. Once a probability for each semantic class is calculated using the trained classifier and each pixel is labeled with a semantic class, a graph-based method can be used to refine the pixel labeling with respect to RGB image structures such as organ boundaries, while taking into account the confidences (probabilities) for each pixel for each semantic class. The graph-based method can be based on a conditional random field formulation (CRF) that uses the probabilities calculated for the pixels in the current frame and an organ boundary extracted in the current frame using another segmentation technique to refine the pixel labeling in the current frame. A graph representing the semantic segmentation of the current frame is generated. The graph includes a plurality of nodes and a plurality of edges connecting the nodes. The nodes of the graph represent the pixels in the current frame and the corresponding confidences for each semantic class. The weights of the edges are derived from a boundary extraction procedure performed on the 2.5D depth data and the 2D RGB data. The graph-based method groups the nodes into groups representing the semantic labels and finds the best grouping of the nodes to minimize an energy function that is based on the semantic class probability for each node and the edge weights connecting the nodes, which act as a penalty function for edges connecting nodes that cross the extracted organ boundary. This results in a refined semantic map for the current frame, which can be displayed on the display device of the computer system.

At step 120, steps 108-118 are repeated for a plurality of frames of the intra-operative image stream. Accordingly, for each frame, the pre-operative 3D model of the target organ is fused with that frame and the trained semantic classifier is updated (re-trained) using semantic labels propagated to that frame from the pre-operative 3D medical image data. These steps can be repeated for a predetermined number of frames or until the trained semantic classifier converges.

At step 122, the trained semantic classifier is used to perform semantic segmentation on additional acquired frames of the intra-operative image stream. It is also possible that the trained semantic classifier be used to perform semantic segmentation in frames of a different intra-operative image sequence, such as in a different surgical procedure for the patient or for a surgical procedure for a different patient. Additional details relating to semantic segmentation of intra-operative image using a trained semantic classifier are described in [Siemens Ref. No. 201424415—I will fill in the necessary information], which is incorporated herein by reference in its entirety. Since redundant image data is captured and used for 3D stitching, the generated semantic information can be fused and verified with the pre-operative 3D medical image data using 2D-3D correspondences.

In a possible embodiment, additional frames of the intra-operative image sequence corresponding to a complete scanning of the target organ can be acquired and semantic segmentation can be performed on each of the frames, and the semantic segmentation results can be used to guide the 3D stitching of those frames to generate an updated intra-operative 3D model of the target organ. The 3D stitching can be performed by align individual frames with each other based on correspondences in different frames. In an advantageous implementation, connected regions of pixels of the target organ (e.g., connected regions of liver pixels) in the semantically segmented frames can be used to estimate the correspondences between the frames. Accordingly, the intra-operative 3D model of the target organ can be generated by stitching multiple frames together based on the semantically segmented connected regions of the target organ in the frames. The stitched intra-operative 3D model can be semantically enriched with the probabilities of each considered object class, which are mapped to the 3D model from the semantic segmentation results of the stitched frames used to generate the 3D model. In an exemplary implementation, the probability map can be used to “colorize” the 3D model by assigning a class label to each 3D point. This can be done by quick look ups using 3D to 2D projections known from the stitching process. A color can then be assigned to each 3D point based on the class label. This updated intra-operative 3D model may be more accurate than the original intra-operative 3D model used to perform the rigid registration between the pre-operative 3D medical image data and the intra-operative image stream. Accordingly, step 106 can be repeated to perform the rigid registration using the updated intra-operative 3D model, and then steps 108-120 can be repeated for a new set of frames of the intra-operative image stream in order to further update the trained classifier. This sequence can be repeated to iteratively improve the accuracy of the registration between the intra-operative image stream and the pre-operative 3D medical image data and the accuracy of the trained classifier.

Semantic labeling of laparoscopic and endoscopic imaging data and segmentation into various organs can be time consuming since accurate annotations are required for various viewpoints. The above described methods make use of labeled pre-operative medical image data, which can be obtained from highly automated 3D segmentation procedures applied to CT, MR, PET, etc. Through fusion of the models to laparoscopic and endoscopic imaging data, a machine learning based semantic classifier can be trained for laparoscopic and endoscopic imaging data without the need to label images/video frames in advance. Training a generic classifier for scene parsing (semantic segmentation) is challenging since real-world variations occur in shape, appearance, texture, etc. The above described methods make us of specific patient or scene information, which is learned on the fly during acquisition and navigation. Furthermore, having available the fused information (RGB-D and pre-operative volumetric data) and their relations enables an efficient presentation of semantic information during navigation in a surgical procedure. Having available the fused information (RGB-D and pre-operative volumetric data) and their relations on the level of semantics also enables an efficient parsing of information for reporting and documentation.

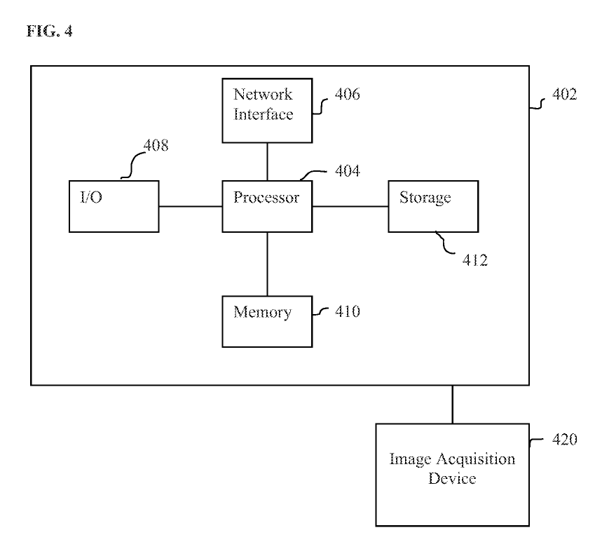

The above-described methods for scene parsing and model fusion in intra-operative image streams may be implemented on a computer using well-known computer processors, memory units, storage devices, computer software, and other components. A high-level block diagram of such a computer is illustrated in FIG. 4. Computer 402 contains a processor 404, which controls the overall operation of the computer 402 by executing computer program instructions which define such operation. The computer program instructions may be stored in a storage device 412 (e.g., magnetic disk) and loaded into memory 410 when execution of the computer program instructions is desired. Thus, the steps of the methods of FIGS. 1 and 2 may be defined by the computer program instructions stored in the memory 410 and/or storage 412 and controlled by the processor 404 executing the computer program instructions. An image acquisition device 420, such as a laparoscope, endoscope, CT scanner, MR scanner, PET scanner, etc., can be connected to the computer 402 to input image data to the computer 402. It is possible that the image acquisition device 420 and the computer 402 communicate wirelessly through a network. The computer 402 also includes one or more network interfaces 406 for communicating with other devices via a network. The computer 402 also includes other input/output devices 408 that enable user interaction with the computer 402 (e.g., display, keyboard, mouse, speakers, buttons, etc.). Such input/output devices 408 may be used in conjunction with a set of computer programs as an annotation tool to annotate volumes received from the image acquisition device 420. One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for scene parsing in an intra-operative image stream, comprising:
receiving a current frame of an intra-operative image stream including a 2D image channel and a 2.5D depth channel;
fusing a 3D pre-operative model of a target organ segmented in pre-operative 3D medical image data to the current frame of the intra-operative image stream;
propagating semantic label information from the pre-operative 3D medical image data to each of a plurality of pixels in the current frame of the intra-operative image stream based on the fused pre-operative 3D model of the target organ, resulting in a rendered label map for the current frame of the intra-operative image stream; and
training a semantic classifier based on the rendered label map for the current frame of the intra-operative image stream.

2. The method of claim 1, wherein fusing a 3D pre-operative model of a target organ segmented in pre-operative 3D medical image data to the current frame of the intra-operative image stream comprises:
performing a non-rigid registration between the pre-operative 3D medical image data and the intra-operative image stream; and
deforming the 3D pre-operative model of the target organ using a computational biomechanical model for the target organ to align the pre-operative 3D medical image data to the current frame of the intra-operative image stream.

3. The method of claim 2, wherein performing a non-rigid registration between the pre-operative 3D medical image data and the intra-operative image stream comprises:
stitching a plurality of frames of the intra-operative image stream to generate a 3D intra-operative model of the target organ; and
performing a rigid registration between the 3D pre-operative model of the target organ and the 3D intra-operative model of the target organ.

4. (canceled)

5. The method of claim 2, wherein deforming the 3D pre-operative model of the target organ comprises:
estimating correspondences between the 3D pre-operative model of the target organ and the target organ in the current frame;
estimating forces on the target organ based on the correspondences; and
simulating deformation of the 3D pre-operative model of the target organ based on the estimated forces using the computational biomechanical model for the target organ.

6. The method of claim 1, wherein propagating semantic label information comprises:
aligning the pre-operative 3D medical image data to the current frame of the intra-operative image stream based on the fused pre-operative 3D model of the target organ;
estimating a projection image in the 3D medical image data corresponding to the current frame of the intra-operative image stream based on a pose of the current frame; and
rendering the rendered label map for the current frame of the intra-operative image stream by propagating a semantic label from each of a plurality of pixel locations in the estimated projection image in the 3D medical image data to a corresponding one of the plurality of pixels in the current frame of the intra-operative image stream.

7. The method of claim 1, wherein training a semantic classifier based on the rendered label map for the current frame of the intra-operative image stream comprises:
updating a trained semantic classifier based on the rendered label map for the current frame of the intra-operative image stream.

8. The method of claim 1, wherein training a semantic classifier based on the rendered label map for the current frame of the intra-operative image stream comprises:
sampling training samples in each of one or more labeled semantic classes in the rendered label map for the current frame of the intra-operative image stream;
extracting statistical features from the 2D image channel and the 2.5D depth channel in a respective image patch surrounding each of the training samples in the current frame of the intra-operative image stream; and
training the semantic classifier based on the extracted statistical features for each of the training samples and a semantic label associated with each of the training samples in the rendered label map.

9. (canceled)

10. The method of claim 8, further comprising:
performing semantic segmentation on the current frame of the intra-operative image stream using the trained semantic classifier;
comparing a label map resulting from performing semantic segmentation on the current frame using the trained classifier with the rendered label map for the current frame; and
repeating the training of the semantic classifier using additional training samples sampled from each of the one or more semantic classes and performing the semantic segmentation using the trained semantic classifier until the label map resulting from performing semantic segmentation on the current frame using the trained classifier converges to the rendered label map for the current frame.

11-12. (canceled)

13. The method of claim 10, further comprising:
repeating the training of the semantic classifier using additional training samples sampled from each of the one or more semantic classes and performing the semantic segmentation using the trained semantic classifier until a pose of the target organ converges in the label map resulting from performing semantic segmentation on the current frame using the trained classifier.

14-16. (canceled)

17. An apparatus for scene parsing in an intra-operative image stream, comprising:
a processor configured to:
receive a current frame of an intra-operative image stream including a 2D image channel and a 2.5D depth channel;
fuse a 3D pre-operative model of a target organ segmented in pre-operative 3D medical image data to the current frame of the intra-operative image stream;
propagate semantic label information from the pre-operative 3D medical image data to each of a plurality of pixels in the current frame of the intra-operative image stream based on the fused pre-operative 3D model of the target organ, resulting in a rendered label map for the current frame of the intra-operative image stream; and
train a semantic classifier based on the rendered label map for the current frame of the intra-operative image stream.

18. The apparatus of claim 17, wherein the processor is further configured to:
perform a non-rigid registration between the pre-operative 3D medical image data and the intra-operative image stream; and
deform the 3D pre-operative model of the target organ using a computational biomechanical model for the target organ to align the pre-operative 3D medical image data to the current frame of the intra-operative image stream.

19. (canceled)

20. The apparatus of claim 17, wherein the processor is further configured to:
sample training samples in each of one or more labeled semantic classes in the rendered label map for the current frame of the intra-operative image stream;
extract statistical features from the 2D image channel and the 2.5D depth channel in a respective image patch surrounding each of the training samples in the current frame of the intra-operative image stream; and
train the semantic classifier based on the extracted statistical features for each of the training samples and a semantic label associated with each of the training samples in the rendered label map.

21. (canceled)

22. The apparatus of claim 20, wherein the processor is further configured to:
perform semantic segmentation on the current frame of the intra-operative image stream using the trained semantic classifier.

23-24. (canceled)

25. A non-transitory computer readable medium storing computer program instructions for scene parsing in an intra-operative image stream, the computer program instructions when executed by a processor cause the processor to perform operations comprising:
receiving a current frame of an intra-operative image stream including a 2D image channel and a 2.5D depth channel;
fusing a 3D pre-operative model of a target organ segmented in pre-operative 3D medical image data to the current frame of the intra-operative image stream;
propagating semantic label information from the pre-operative 3D medical image data to each of a plurality of pixels in the current frame of the intra-operative image stream based on the fused pre-operative 3D model of the target organ, resulting in a rendered label map for the current frame of the intra-operative image stream; and
training a semantic classifier based on the rendered label map for the current frame of the intra-operative image stream.

26. The non-transitory computer readable medium of claim 25, wherein fusing a 3D pre-operative model of a target organ segmented in pre-operative 3D medical image data to the current frame of the intra-operative image stream comprises:
performing a non-rigid registration between the pre-operative 3D medical image data and the intra-operative image stream; and
deforming the 3D pre-operative model of the target organ using a computational biomechanical model for the target organ to align the pre-operative 3D medical image data to the current frame of the intra-operative image stream.

27. The non-transitory computer readable medium of claim 26, wherein performing an initial rigid registration between the pre-operative 3D medical image data and the intra-operative image stream comprises:
stitching a plurality of frames of the intra-operative image stream to generate a 3D intra-operative model of the target organ; and
performing a rigid registration between the 3D pre-operative model of the target organ and the 3D intra-operative model of the target organ.

28. (canceled)

29. The non-transitory computer readable medium of claim 26, wherein deforming the 3D pre-operative model of the target organ comprises:
estimating correspondences between the 3D pre-operative model of the target organ and the target organ in the current frame;
estimating forces on the target organ based on the correspondences; and
simulating deformation of the 3D pre-operative model of the target organ based on the estimated forces using the computational biomechanical model for the target organ.

30. The non-transitory computer readable medium of claim 25, wherein propagating semantic label information comprises:
aligning the pre-operative 3D medical image data to the current frame of the intra-operative image stream based on the fused pre-operative 3D model of the target organ;
estimating a projection image in the 3D medical image data corresponding to the current frame of the intra-operative image stream based on a pose of the current frame; and
rendering the rendered label map for the current frame of the intra-operative image stream by propagating a semantic label from each of a plurality of pixel locations in the estimated projection image in the 3D medical image data to a corresponding one of the plurality of pixels in the current frame of the intra-operative image stream.

31. (canceled)

32. The non-transitory computer readable medium of claim 26, wherein training a semantic classifier based on the rendered label map for the current frame of the intra-operative image stream comprises:
sampling training samples in each of one or more labeled semantic classes in the rendered label map for the current frame of the intra-operative image stream;
extracting statistical features from the 2D image channel and the 2.5D depth channel in a respective image patch surrounding each of the training samples in the current frame of the intra-operative image stream; and
training the semantic classifier based on the extracted statistical features for each of the training samples and a semantic label associated with each of the training samples in the rendered label map.

33. (canceled)

34. The non-transitory computer readable medium of claim 32, wherein the operations further comprise:
performing semantic segmentation on the current frame of the intra-operative image stream using the trained semantic classifier;
comparing a label map resulting from performing semantic segmentation on the current frame using the trained classifier with the rendered label map for the current frame; and
repeating the training of the semantic classifier using additional training samples sampled from each of the one or more semantic classes and performing the semantic segmentation using the trained semantic classifier until the label map resulting from performing semantic segmentation on the current frame using the trained classifier converges to the rendered label map for the current frame.

35-36. (canceled)

37. The non-transitory computer readable medium of claim 34, wherein the operations further comprise:
repeating the training of the semantic classifier using additional training samples sampled from each of the one or more semantic classes and performing the semantic segmentation using the trained semantic classifier until a pose of the target organ converges in the label map resulting from performing semantic segmentation on the current frame using the trained classifier.

38-40. (canceled)
